(19) United States
(12) Patent Application Publication
(10) Pub. No.: US 2019/0220379 A1
(43) Pub. Date: Jul. 18, 2019

(54) Troubleshooting Method, Apparatus, and Device

(71) Applicant: Huawei Technologies Co., Ltd., Shenzhen (CN)

(72) Inventor: Sicong Li, Hangzhou (CN)

(21) Appl. No.: 16/362,196

(22) Filed: Mar. 22, 2019

Related U.S. Application Data
(63) Continuation of application No. PCT/CN2017/112358, filed on Nov. 22, 2017.

(30) Foreign Application Priority Data
Dec. 6, 2016 (CN) 201611110928.0

(51) Int. Cl. G06F 11/20

(52) U.S. Cl. CPC G06F 11/2094; G06F 2201/82

(57) ABSTRACT

A troubleshooting method, apparatus, and device, where the method includes that a redundant array of independent disks (RAID) controller receives information about a faulty disk in any RAID group, where the information about the faulty disk includes a capacity and a type of the faulty disk, selects an idle disk from a hot spare disk resource pool that matches the RAID group to restore data of the faulty disk, where a capacity of the idle disk in the hot spare disk resource pool is greater than or equal to the capacity of the faulty disk, and a type of the idle disk of the hot spare disk resource pool is the same as the type of the faulty disk, the hot spare disk resource pool is pre-created by the RAID controller, and the hot spare disk resource pool includes one or more idle disks in at least one storage node.

### CROSS-REFERENCE TO RELATED APPLICATIONS

This application is a continuation of International Patent Application No. PCT/CN2017/112358 filed on Nov. 22, 2017, which claims priority to Chinese Patent Application No. 201611110928.0 filed on Dec. 6, 2016. The disclosures of the aforementioned applications are hereby incorporated by reference in their entireties.

### TECHNICAL FIELD

The present application relates to the storage field, and in particular, to a troubleshooting method, apparatus, and device.

### BACKGROUND

A redundant array of independent disks (RAID) is a technology that combines a plurality of independent disks into a disk group according to different configuration policies. The disk group, also referred to as a RAID group, provides better storage performance than a single disk and also provides a data backup technology. The RAID is more widely used in a storage field due to two advantages a high speed and high security.

In the other approaches, a RAID group is usually managed by a RAID controller, and configuration policies of the RAID group are mainly classified into a RAID 0, a RAID 1, a RAID 2, a RAID 3, a RAID 4, a RAID 5, a RAID 6, a RAID 7, a RAID 10, and a RAID 50. An N+M mode needs to be configured for the configuration policies greater than the RAID 3, where N and M are positive integers greater than 1, N represents a quantity of data disks, and M represents a quantity of parity disks. In addition, a hot spare disk is also configured in the RAID group. When a disk fault occurs in the RAID group, the RAID controller can restore data from the faulty disk to the hot spare disk based on parity data in the parity disk and data in the data disk to improve system reliability.

A local disk of a server is usually used as the hot spare disk. The hot spare disk does not store data normally. When another physical disk being used in the RAID group is damaged, the hot spare disk may automatically take over a storage function of the damaged disk to carry data in the damaged disk and ensure interrupted data access. However, when a RAID group is created, a local disk of the server needs to be designated as a hot spare disk in advance. In addition, RAID controllers in a same server may simultaneously create a plurality of RAID groups, and each RAID group needs to be configured with a hot spare disk. This causes a limited quantity of hot spare disks in a same storage device. Consequently, system reliability is affected.

### SUMMARY

Embodiments of the present application provide a troubleshooting method, apparatus, and device in order to resolve a problem that a quantity of hot spare disks in a same storage device is limited in the other approaches, thereby improving reliability of a storage system.

According to a first aspect, a troubleshooting method is provided and applied to a troubleshooting system. The system includes at least one service node and at least one storage node. The storage node communicates with the service node using a network. Each storage node includes at least one idle disk. Each service node includes a RAID controller and a RAID group. The RAID controller combines a plurality of disks into one disk group according to different configuration policies. The disk group may be also referred to as a RAID group. The RAID controller monitors and manages the RAID group. When the RAID controller obtains information about a faulty disk in any RAID group in a service node on which the RAID controller is located. The information about the faulty disk includes a capacity and a type of the faulty disk. The RAID controller selects, from a hot spare disk resource pool that matches the RAID group, an idle disk as a hot spare disk to restore data of the faulty disk. The hot spare disk resource pool is pre-created by the RAID controller. The hot spare disk resource pool includes one or more idle disks in the at least one storage node. A capacity of the idle disk selected by the RAID controller is greater than or equal to the capacity of the faulty disk. A type of the idle disk is the same as the type of the faulty disk.

Optionally, the hot spare disk resource pool may include at least one of a logical disk and at least one a physical disk.

Further, the storage node may also include a RAID controller. The RAID controller uses a plurality of hard disks in the storage node to form a RAID group, divides the RAID group into a plurality of logical disks, and sends information about an unused logical disk to the RAID controller of the service node. The information about the logical disk includes information such as a capacity and a type of the logical disk, a logical disk identifier, and a RAID group to which the logical disk belongs.

The RAID controller may determine a first hot spare disk resource pool in any one of the following manners.

Manner 1: Based on an identifier of a hot spare disk resource pool, the RAID controller selects, from one or more hot spare disk resource pools that match the RAID group, one hot spare disk resource pool as the first hot spare disk resource pool.

Manner 2: The RAID controller randomly selects, from one or more hot spare disk resource pools that match the RAID group, one hot spare disk resource pool as the first hot spare disk resource pool.

A capacity of an idle disk in the first hot spare disk resource pool is greater than or equal to the capacity of the faulty disk, and a type of the idle disk in the first hot spare disk resource pool is the same as the type of the faulty disk.

Further, after determining the first hot spare disk resource pool, the RAID controller may determine a first idle disk as the hot spare disk in any one of the following manners.

Manner 1: Based on an identifier of a hard disk, the RAID controller successively selects an idle disk from the first hot spare disk resource pool as the first idle disk.

Manner 2: The RAID controller randomly selects an idle disk from the first hot spare disk resource pool as the first idle disk.

In a possible implementation, the storage node further includes a storage controller. The RAID controller first obtains information about the idle disk that is sent by the storage controller. The information about the idle disk includes the type and the capacity of the idle disk. Then the RAID controller creates at least one hot spare disk resource pool based on the information about the idle disk. Each hot spare disk resource pool includes at least one idle disk having a same capacity and/or a same type. When creating the RAID group, the RAID controller determines, based on a type and a capacity of a hard disk in the RAID group, one or more hot spare disk resource pools that match the RAID group, and records a mapping relationship between the RAID group and the one or more hot spare disk resource pools that match the RAID group. When obtaining the information about the faulty disk in any RAID group, the RAID controller may select, based on the mapping relationship and the information about the faulty disk, an idle disk of a hot spare disk resource pool from hot spare disk resource pools that match the RAID group to restore data of the faulty disk.

In a possible implementation, the information about the idle disk further includes information about a fault domain of the hard disk. The idle disk selected by the RAID controller is not in a same fault domain as a used hot spare disk in the RAID group. The information about the fault domain is used to identify a relationship between areas in which different hard disks are located, data may be lost when different hard disks in a same fault domain are faulty simultaneously, and data may not be lost when different hard disks in different fault domains are faulty simultaneously.

Further, the information about the idle disk further includes the information about the fault domain of the disk. The fault domain is used to identify the relationship between areas in which different disks are located. The areas may be different areas obtained through division based on a physical location of a storage node in which a disk is located. The physical location may be at least one of a rack, a cabinet, and a subrack in which the storage node is located. If data may not be lost when storage nodes or components of storage nodes in two different areas are faulty simultaneously, disks in the two areas belong to different fault domains. If data may be lost when storage nodes or components of storage nodes in two different areas are faulty simultaneously, disks in the two areas belong to a same fault domain.

Optionally, the area in which the hard disk is located may be a logical area. Further, the storage node in which the disk is located is divided into different logical areas according to a preset policy such that normal operation of an application program is not affected when storage nodes or components (such as a network adapter and a hard disk) of storage nodes in different logical areas are faulty. A fault of storage nodes or components of storage nodes in a same logical area may affect a service application. The preset policy may be dividing a storage node into different logical areas based on a service requirement. For example, disks in a same storage node are divided into one logical area, and disks in different logical nodes are divided into different logical areas. In this case, when a single storage node is faulty as a whole or a component of a storage node is faulty, normal operation of another storage node is not affected.

In a possible implementation, after the RAID controller selects the idle disk from the hot spare disk resource pool that matches the RAID group, the RAID controller needs to determine, with a storage controller corresponding to the idle disk, that a state of the idle disk is “unused” such that a data restoration process of the faulty disk can be started. A specific state determining process is as follows. The RAID controller sends a first request message to the storage controller. The first request message is used to determine the state of the selected idle disk. When receiving a response result that is of the first request message and that is used to indicate that the state of the idle disk selected by the RAID controller is “unused”, the RAID controller locally mounts the selected idle disk, and performs faulty-data restoration processing of the RAID group.

In a possible implementation, the RAID controller rewrites, based on data in a non-faulty data disk and data in a non-faulty parity disk in the RAID group, the data of the faulty disk into the hot spare disk selected by the RAID controller in order to restore the data of the faulty disk.

Based on the foregoing description, according to the troubleshooting method provided in the present application, the RAID controller of the service node forms the hot spare disk resource pool using the idle disk of the storage node, establishes the mapping relationship between the RAID group and the hot spare disk resource pool, and when there is a faulty disk in the RAID group, selects a hot spare disk from the hot spare disk resource pool that matches the RAID group to complete data restoration of the faulty disk. A quantity of storage nodes may be continuously increased based on a service requirement to ensure that a quantity of hard disks in the hot spare disk resource pool can be infinitely expanded in order to resolve a problem that a quantity of hot spare disks is limited in the other approaches, thereby improving system reliability. In addition, local disks of the service node may be used to establish the RAID group in order to improve utilization of the local disk.

According to a second aspect, the present application provides a troubleshooting apparatus, and the apparatus includes modules configured to perform the troubleshooting method in any one of the first aspect or the possible implementations of the first aspect.

According to a third aspect, the present application provides a troubleshooting device. The device includes a processor, a memory, a communications interface, and a bus. The processor, the memory, and the communications interface are connected using the bus to implement mutual communication. The memory is configured to store a computer execution instruction. When the device is running, the processor executes the computer execution instruction in the memory to perform, using a hardware resource in the device, the method in any one of the first aspect or the possible implementations of the first aspect.

According to a fourth aspect, the present application provides a computer readable medium configured to store a computer program, and the computer program includes an instruction used to perform the method in any one of the first aspect or the possible implementations of the first aspect.

According to a fifth aspect, the present application provides a troubleshooting device. The device includes a RAID card, a memory, a communications interface, and a bus. The RAID card includes a RAID controller and a memory. The RAID controller and the memory of the RAID card communicate with each other using the bus. The RAID card, the memory, and the communications interface communicate with each other using the bus. The memory of the RAID card is configured to store a computer execution instruction. When the device is running, the RAID controller executes the computer execution instruction in the memory of the RAID card to perform, using a hardware resource in the device, the method in any one of the first aspect or the possible implementations of the first aspect.

In conclusion, according to the data processing method, apparatus, and device provided in this application, a hot spare disk resource pool is implemented using an idle disk of a cross-network storage node, and a mapping relationship between the hot spare disk resource pool and each RAID group is established. When there is a faulty disk in any RAID group, one hot spare disk resource pool may be selected from hot spare disk resource pools that match the RAID group, and an idle disk in the hot spare disk resource pool may be selected as a hot spare disk to restore faulty data. A quantity of idle disks in the hot spare disk resource pool may be adjusted based on a service requirement in order to resolve a problem that system reliability is affected by a limited quantity of hard disks in the hot spare disk resource pool in the other approaches. In addition, all local disks of the service node may be used as a data disk and a parity disk of the RAID group, which improves utilization of the local disk.

Based on the implementations provided in the foregoing aspects, this application may further provide more implementations through combination.

### BRIEF DESCRIPTION OF DRAWINGS

To describe the technical solutions in some of the embodiments of the present application more clearly, the following briefly introduces the accompanying drawings describing the embodiments.

FIG. 1 is a logical block diagram of a troubleshooting system according to an embodiment of the present application;

FIG. 2 is a schematic flowchart of a troubleshooting method according to an embodiment of the present application;

FIG. 3A is a schematic flowchart of another troubleshooting method according to an embodiment of the present application;

FIG. 3B is a schematic flowchart of another troubleshooting method according to an embodiment of the present application;

FIG. 3C is a schematic flowchart of another troubleshooting method according to an embodiment of the present application;

FIG. 4 is a schematic diagram of a troubleshooting apparatus according to an embodiment of the present application;

FIG. 5 is a schematic diagram of a troubleshooting device according to an embodiment of the present application; and

FIG. 6 is a schematic diagram of another troubleshooting device according to an embodiment of the present application.

### DESCRIPTION OF EMBODIMENTS

Technical solutions in embodiments of the present application are clearly described in the following with reference to the accompanying drawings.

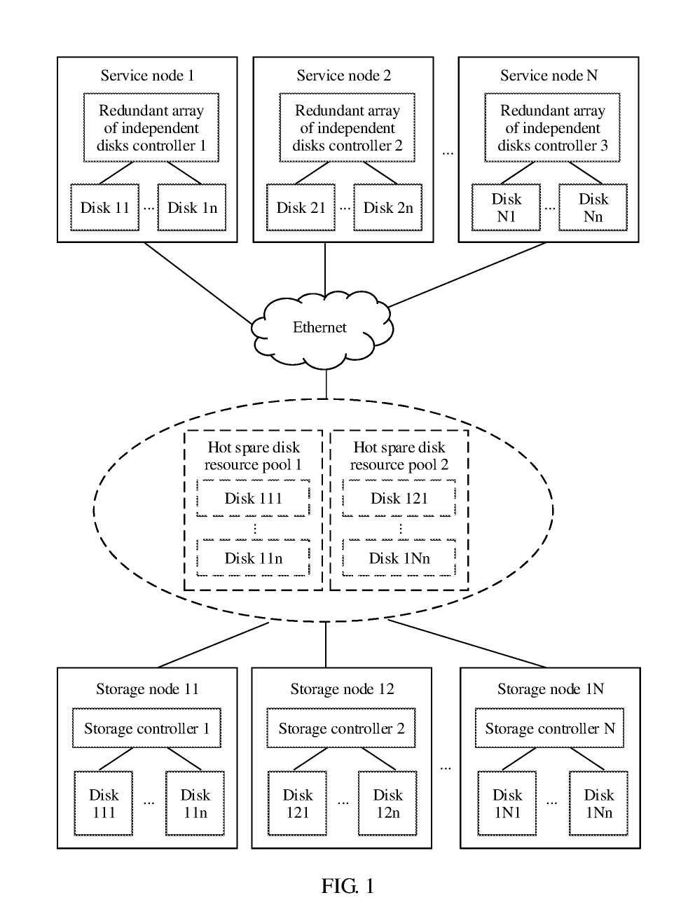

FIG. 1 is a schematic diagram of a troubleshooting system according to an embodiment of the present application. As shown in FIG. 1, the system includes at least one service node and at least one storage node, and the service node communicates with the storage node using a network.

Optionally, the service node may communicate with the storage node using Ethernet, or using lossless Ethernet data center bridging (DCB) and InfiniBand (IB) that support remote direct memory access (RDMA).

Optionally, a RAID controller exchanges data with a hot spare disk resource pool using a standard network storage protocol. For example, the storage protocol may be a network-based Non-Volatile Memory Express over Fabrics (NoF) protocol, or may be an Internet Small Computer Systems Interface (iSCSI) Extensions for RDMA (iSER) protocol used to transmit a command and data of an iSCSI protocol through RDMA, or a small computer system interface (SCSI) RDMA protocol (SRP) used to transmit a command and data of an SCSI protocol in a manner of RDMA.

The service node may be a server configured to provide a computing resource (for example, a central processing unit (CPU) and a memory), a network resource (for example, a network adapter), and a storage resource (for example, a hard disk) for an application program of a user. Each service node includes a RAID controller. The RAID controller may combine a plurality of local disks into one or more disk groups according to different configuration policies. The configuration policies are mainly classified into a RAID 0, a RAID 1, a RAID 2, a RAID 3, a RAID 4, a RAID 5, a RAID 6, a RAID 7, a RAID 10, and a RAID 50. An N+M mode needs to be configured for the configuration policies greater than the RAID 3, where N and M are positive integers greater than 1, N represents a quantity of data disks that store data in member disks of the RAID group, and M represents a quantity of parity disks that store parity codes in the member disks of the RAID group. For example, five disks in the service node are used to create a RAID group according to the configuration policy RAID 5. The local disk is a disk in a same server as the RAID controller. For example, a disk 11, . . . , and a disk 1n shown in FIG. 1 may be referred to as local disks of a service node 1. The RAID controller may record information about member disks in each RAID group into metadata information. The metadata information includes a configuration policy of each RAID group, a capacity and a type of the member disk, and the like. The RAID controller can monitor each RAID group based on the metadata information.

It is noteworthy that the RAID controller may be implemented by a dedicated RAID card, or may be implemented by a processor of the service node. When a function of the RAID controller is implemented by the RAID card, the metadata information is stored in a memory of the RAID card. When a function of the RAID controller is implemented by the processor of the service node, the metadata information is stored in a memory of the service node. The memory may be any medium that can store program code, such as a universal serial bus (USB) flash drive, a removable hard disk, a read-only memory (ROM), a random access memory (RAM), a magnetic disk, or an optical disc. The processor may be a CPU. The processor may be another general purpose processor, a digital signal processor (DSP), an application-specific integrated circuit (ASIC), a field programmable gate array (FPGA) or another programmable logic device, a discrete gate, a transistor logic device, a discrete hardware component, or the like. The general purpose processor may be a microprocessor, or the processor may be any conventional processor or the like.

It is also noteworthy that a disk of the service node may be divided into two categories a solid state disk (SSD) and a hard disk drive (HDD). Based on different data interfaces, the HDD may be further divided into the following several types an advanced technology attachment (ATA) hard disk, an SCSI hard disk, a Serial Attached SCSI (SAS) hard disk, a Serial ATA (SATA) hard disk. Attributes such as an interface, a size, or a hard disk read/write rate of these types of hard disks are different from each other.

The storage node may be a server or a storage array, and the storage node is configured to provide a storage resource for an application program of the user. In this application, the storage node is further configured to provide the hot spare disk resource pool for the RAID group of the service node. Each storage node includes a storage controller and at least one disk. The storage node is similar to the service node in that a disk type of the storage node may also be divided into several categories an SSD, an ATA, a SCSI, a SAS, and a SATA. In the troubleshooting system, a storage node may be designated to provide only an idle disk of the hot spare disk resource pool, i.e., all disks in the designated storage node may be configured to provide the idle disk of the hot spare disk resource pool.

Optionally, disks of a same storage node may be configured to provide an idle disk of the hot spare disk resource pool, and may be further configured to provide a storage resource for a designated application program. For example, some disks of a storage node may be further used as a storage device that stores an Oracle database. In this case, each storage controller may collect information about an idle disk of a storage node on which the storage controller is located. The RAID controller of the service node collects information about an idle disk of each storage node, and combines the idle disks into the hot spare disk resource pool.

For example, as shown in FIG. 1, a storage node 11 includes a disk 111, a disk 112, . . . , and a disk 11n, a storage node 12 includes a disk 121, a disk 122, . . . , and a disk 12n, and a storage node 1N includes a disk 1N1, a disk 1N2, . . . , and a disk 1Nn, where both N and n are positive integers greater than 1. It is assumed that the storage node 11 is a designated storage node dedicated to providing the idle disk of the hot spare disk resource pool, while a disk of another storage node is not only configured to provide a storage resource for a designated application program, but also configured to provide an idle disk of the hot spare disk resource pool. Further, an idle disk in the storage node 12 includes the disk 121 and the disk 122, and an idle disk in a storage node 1N is the disk 1Nn. In this case, a RAID controller of any service node in the troubleshooting system may obtain information about an idle disk in each storage node using the network. The idle disk includes the disk 111, the disk 112, . . . , the disk 11n of the storage node 11, the disk 121, and the disk 122 of the storage node 12, and the disk 1Nn of the storage node 1N. The information about the idle disk includes a capacity and a type of each disk. For example, a type of the disk 111 is a SAS disk and a capacity is 300 gigabytes (GB).

Optionally, the hot spare disk resource pool may also include a logical disk. Further, the storage node may also include a RAID controller. The RAID controller uses a plurality of disks in the storage node to form a RAID group, divides the RAID group into a plurality of logical disks, and sends information about an unused logical disk to the RAID controller of the service node. The information about the logical disk includes information such as a capacity and a type of the logical disk, a logical disk identifier, and a RAID group to which the logical disk belongs.

Optionally, the hot spare disk resource pool may include both a physical disk and a logical disk, to be specific, idle disks provided by some storage nodes are physical disks, and idle disks provided by some storage nodes are logical disks. The RAID controller of the service node may distinguish between different types of disks based on a type in order to create different hot spare disk resource pools.

It is noteworthy that the troubleshooting system shown in FIG. 1 is merely an example, quantities and types of disks of different service nodes in the troubleshooting system do not constitute a limitation to the present application, and quantities and types of disks of different storage nodes also do not constitute a limitation on the present application. In addition, a quantity of service nodes and a quantity of storage nodes may be equal or may not be equal.

Optionally, in the troubleshooting system shown in FIG. 1, the information about the idle disk further includes information about a fault domain of the disk. The fault domain is used to identify a relationship between areas in which different disks are located, data may be lost when different disks in a same fault domain are faulty, and data may not be lost when different disks in different fault domains are faulty. The area may be a physical area. To be specific, different areas are obtained through division based on a physical location of a storage node in which a disk is located. The physical location may be at least one of a rack, a cabinet, and a subrack in which the storage node is located. If data may not be lost when storage nodes or components of storage nodes in two different areas are faulty, disks in the two areas belong to different fault domains. If data may be lost when storage nodes or components of storage nodes in two different areas are faulty, disks in the two areas belong to a same fault domain.

For example, Table 1 is an example of a storage node physical location identifier. As shown in the table, if storage nodes in a same cabinet share a set of power supply devices, when the power supply device is faulty, all the storage nodes in the same cabinet are faulty. In this case, disks of different storage nodes whose physical locations are in the same cabinet belong to a same fault domain, and disks of different storage nodes whose physical locations are not in the same cabinet belong to different fault domains. A storage node 1 and a storage node 2 are located in different subracks of a same cabinet of a same rack. In this case, disks of the storage node 1 and the storage node 2 belong to a same fault domain. To be specific, when a power supply device is faulty, disks in the storage node 1 and the storage node 2 cannot operate normally, and application programs running on the storage node 1 and the storage node 2 are affected. Therefore, the disks of the storage node 1 and the storage node 2 belong to a same fault domain. The storage node 1 and a storage node 3 are separately located in different cabinets and subracks of a same rack. When a power supply device of a cabinet 1 in a rack 1 is faulty, the storage node 1 cannot operate normally, but the storage node 3 is not affected. Therefore, disks of the storage node 1 and the storage node 3 belong to different fault domains.

TABLE 1

| | Rack | Cabinet | Subrack |
|---|---|---|---|
| Storage node 1 | 1 | 1 | 1 |
| Storage node 2 | 1 | 1 | 2 |
| Storage node 3 | 1 | 2 | 1 |

Optionally, in the troubleshooting system shown in FIG. 1, the area in which the disk is located may be a logical area. Further, the storage node in which the disk is located is divided into different logical areas according to a preset policy such that normal operation of an application program is not affected when storage nodes or components (such as a network adapter and a hard disk) of storage nodes in different logical areas are faulty. A fault of storage nodes or components of storage nodes in a same logical area may affect a service application. The preset policy may be dividing a storage node into different logical areas based on a service requirement. For example, disks in a same storage node are divided into one logical area, and disks in different logical nodes are divided into different logical areas. In this case, when a single storage node is faulty as a whole or a component of a storage node is faulty, normal operation of another storage node is not affected.

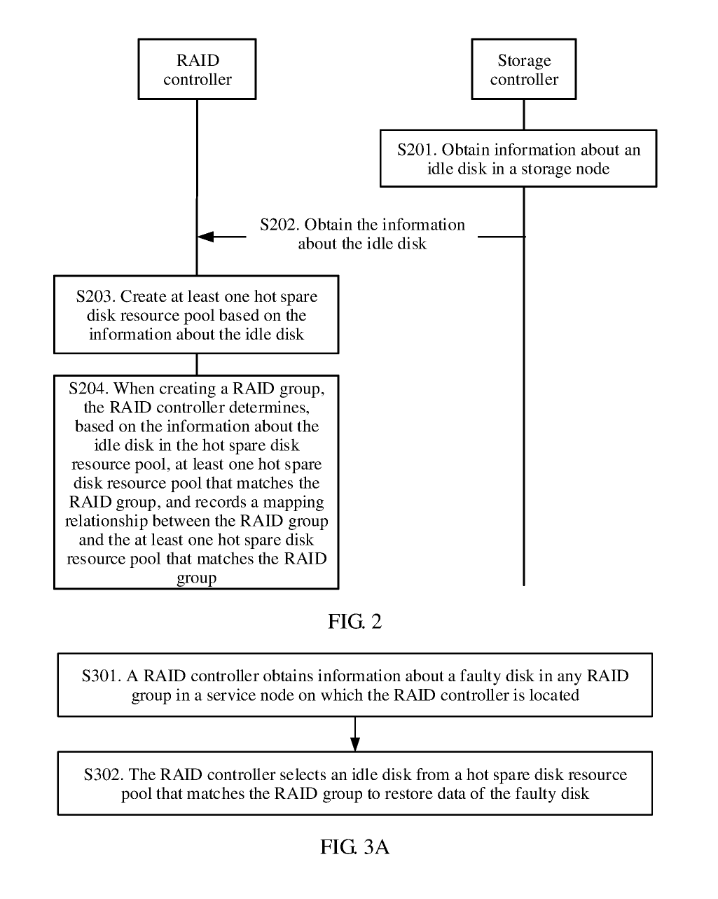

With reference to the foregoing description, a method for creating a hot spare disk resource pool in the troubleshooting system shown in FIG. 1 is described in the following. A RAID group in each service node is managed by a RAID controller of the service node. Therefore, the RAID controller of each service node may pre-create a hot spare disk resource pool. For a simple and clear description of a troubleshooting method provided in the present application, with reference to FIG. 2, the troubleshooting method provided in this embodiment of the present application is further explained using an example in which the troubleshooting system includes one service node and one storage node dedicated to providing an idle disk. As shown in the figure, the method includes the following steps.

Step 201. A storage controller obtains information about an idle disk in the storage node.

The information about the idle disk includes a type and a capacity of the idle disk of the storage node on which the storage controller is located. The type of the idle disk is used to identify a category of the hard disk, such as a SAS and a SATA. When the idle disk includes both a logical disk and a physical disk, the category of the disk may further include a logical disk and a physical disk. The capacity is used to identify a size of the disk, for example, 300 GB and 600 GB.

Optionally, the information about the idle disk further includes information about a fault domain of the disks. One fault domain includes one or more disks. When different disks in a same fault domain are simultaneously faulty, a service application may be interrupted or data may be lost. When different disks in different fault domains are simultaneously faulty, a service is not affected.

Optionally, the storage controller of each storage node may record, using a designated file, information about an idle disk of the storage node on which the storage controller is located, or may record, using a table in a database, information about an idle disk of the storage node on which the storage controller is located. Further, the storage controller may periodically query the information about the idle disk of the storage node on which the storage controller is located, and update content stored in the information.

Step 202. A RAID controller obtains the information about the idle disk.

The RAID controller of the service node sends, to the storage controller, a request message for obtaining the information about the idle disk, and the storage controller sends the information about the idle disk of the storage node to the RAID controller.

Step 203. The RAID controller creates at least one hot spare disk resource pool based on the information about the idle disk.

The RAID controller may create one or more hot spare disk resource pools based on the type and/or the capacity of the idle disk in the information about the idle disk. For example, the RAID controller may create the hot spare disk resource pool based on the type of the idle disk, or may create the hot spare disk resource pool based on the capacity of the idle disk, or may create the hot spare disk resource pool based on the type and the capacity of the idle disk. Then the RAID controller records information about the hot spare disk resource pool.

For example, it is assumed that in the troubleshooting system, an idle disk in a storage node 1 includes a disk 111 and a disk 112, and each disk is a 300 GB SAS disk, an idle disk in a storage node 2 includes a disk 121 and a disk 122, and each disk is a 600 GB SAS disk, and an idle disk in a storage node 3 includes a disk 131 and a disk 132, and each disk is a 500 GB SATA disk. If the hot spare disk resource pool is created based on the type of the disk, the RAID controller may create two hot spare disk resource pools based on the type of the idle disk. A hot spare disk resource pool 1 includes the disk 111, the disk 112, the disk 121, and the disk 122, and a hot spare disk resource pool 2 includes the disk 131 and the disk 132. Types of different idle disks in each hot spare disk resource pool are the same. Alternatively, the RAID controller may create the hot spare disk resource pool based on the capacity of the disk. In this case, the RAID controller may create three hot spare disk resource pools. A hot spare disk resource pool 1 includes the disk 111 and the disk 112, a hot spare disk resource pool 2 includes the disk 121 and the disk 122, and a hot spare disk resource pool 3 includes the disk 131 and the disk 132. Capacities of different idle disks in each hot spare disk resource pool are the same. Alternatively, the RAID controller may create three hot spare disk resource pools based on the type and the capacity of the disk. A hot spare disk resource pool 1 includes the disk 111 and the disk 112, a hot spare disk resource pool 2 includes the disk 121 and the disk 122, and a hot spare disk resource pool 3 includes the disk 131 and the disk 132. Capacities and types of different idle disks in each hot spare disk resource pool are the same.

Optionally, when the idle disks provided by the storage node include a physical disk and a logical disk, i.e., the type of the disk further includes a physical disk and a logical disk, when creating the hot spare disk resource pool, the RAID controller may first divide the idle disks based on the physical disk and the logical disk, and then perform further division based on the capacity of the disk in order to form different hot spare disk resource pools.

Optionally, when the information about the idle disk further includes the information about the fault domain of the disk, the RAID controller may create one or more, hot spare disk resource pools based on three factors of the disk capacity, type, and fault domain. Capacities and types of idle disks in each hot spare disk resource pool are the same and belong to a same fault domain, or capacities and types of idle disks in each hot spare disk resource pool are the same and belong to different fault domains.

For example, if the hot spare disk resource pool is created based on the type, the capacity, and the fault domain of the disk, and the information about the idle disk in the storage node 1 is shown in Table 2, hard disks that have a same capacity and a same type and that are in a same fault domain are created as a hot spare disk resource pool. In this case, based on the information about the idle disk shown in Table 2, the RAID controller may create three hot spare disk resource pools. A hot spare disk resource pool 1 includes a disk 11, a disk 12, and a disk 21, a hot spare disk resource pool 2 includes a disk 31 and a disk 32, and a hot spare disk resource pool 3 includes a disk 43 and a disk 45. Alternatively, disks that have a same capacity and a same type and that are in different fault domains are created as a hot spare disk resource pool. In this case, based on the information about the idle disk shown in Table 2, the RAID controller may create three hot spare disk resource pools. A hot spare disk resource pool 1 includes a disk 11, a disk 31, and a disk 43, a hot spare disk resource pool 2 includes a disk 12, a disk 32, and a disk 45, and a hot spare disk resource pool 3 includes a disk 21. Capacities and types of the idle disks in each hot spare disk resource pool are the same, and fault domains of the hard disks are different.

TABLE 2

| | Disk | | Storage node in | |
|---|---|---|---|---|
| Idle disk | capacity | Disk | which a disk is | Area in which the |
| identifier | in GB | type | located | disk is located |
| Disk 11 | 300 | SAS | Storage node 1 | Area 1 |
| Disk 12 | 300 | SAS | Storage node 1 | Area 1 |
| Disk 21 | 300 | SAS | Storage node 2 | Area 1 |
| Disk 31 | 300 | SAS | Storage node 3 | Area 2 |
| Disk 32 | 300 | SAS | Storage node 3 | Area 2 |
| Disk 43 | 300 | SAS | Storage node 4 | Area 3 |
| Disk 45 | 300 | SAS | Storage node 4 | Area 3 |

After creating the hot spare disk resource pool, the RAID controller may record information about the hot spare disk resource pool using a designated file or database. The information about the hot spare disk resource pool includes a hot spare disk identifier, a disk type, a disk capacity, and a storage node in which a disk is located.

Optionally, the hot spare disk resource pool may also include information about an area in which the idle disk is located.

For example, Table 3 is an example of the information about the hot spare disk resource pool created by the RAID controller based on the information about the idle disk shown in Table 2. As shown in the table, the RAID controller records the information about the hot spare disk resource pool, and the information includes a hot spare disk resource pool identifier, an idle disk identifier, a disk capacity, a disk type, a storage node in which a hard disk is located, and an area in which a disk is located.

TABLE 3

| Hot spare | | | | | |
|---|---|---|---|---|---|
| disk | | | | Storage node | Area in |
| resource | | Idle disk | Idle | in which an | which the |
| pool | Idle disk | capacity | disk | idle disk is | idle disk is |
| identifier | identifier | in GB | type | located | located |
| Hot spare | Disk 11 | 300 | SAS | Storage node 1 | Area 1 |
| disk | Disk 12 | 300 | SAS | Storage node 1 | Area 1 |
| resource | Disk 21 | 300 | SAS | Storage node 2 | Area 1 |
| pool 1 | | | | | |
| Hot spare | Disk 31 | 300 | SAS | Storage node 3 | Area 2 |
| disk | Disk 32 | 300 | SAS | Storage node 3 | Area 2 |
| resource | | | | | |
| pool 2 | | | | | |
| Hot spare | Disk 43 | 300 | SAS | Storage node 4 | Area 3 |
| disk | Disk 45 | 300 | SAS | Storage node 4 | Area 3 |
| resource | | | | | |
| pool 3 | | | | | |

Step 204. When creating a RAID group, the RAID controller determines, based on the information about the idle disk in the hot spare disk resource pool, at least one hot spare disk resource pool that matches the RAID group, and records a mapping relationship between the RAID group and the at least one hot spare disk resource pool that matches the RAID group.

Further, when creating the RAID group, the RAID controller determines, based on the type and capacity of the idle disk in the hot spare disk resource pool, the hot spare disk resource pool that matches the RAID group. The match between the hot spare disk resource pool and the RAID group means that the capacity of the idle disk in the hot spare disk resource pool is greater than or equal to a capacity of a member disk in the RAID group, and the type of the idle disk in the hot spare disk resource pool is the same as a type of the member disk in the RAID group. The mapping relationship between the hot spare disk resource pool and the RAID group may be recorded using a designated file, or may be recorded using a table in a database.

For example, the mapping relationship between the hot spare disk resource pool and the RAID group may be added to the information about the hot spare disk resource pool shown in Table 3. Further, as shown in Table 4, the hot spare disk resource pool 1 matches a RAID 5.

TABLE 4

| | | | | Storage | Area in | |
|---|---|---|---|---|---|---|
| | | | | node in | which a | |
| | | | Disk | which a | storage | Matched |
| | Disk | Disk | capacity | hard disk | node is | RAID |
| Identifier | identifier | type | in GB | is located | located | group |
| Hot spare | Disk 11 | SAS | 300 | Storage | Area 1 | RAID 5 |
| disk | | | | node 1 | | |
| resource | Disk 12 | SAS | 300 | Storage | Area 1 | |
| pool 1 | | | | node 1 | | |
| | Disk 21 | SAS | 300 | Storage | Area 1 | |
| | | | | node 2 | | |

It is noteworthy that when a plurality of RAID groups are formed according to a same configuration policy in a same service node, for example, when there are two RAIDs 5 in a service node 1, an identifier field may be further added to the RAID groups to distinguish between the different RAID groups, such as a first RAID 5 and a second RAID 5.

Optionally, a mapping relationship shown in Table 5 may also be created. The mapping relationship is only used to record a correspondence between a hot spare disk resource pool identifier and a matched RAID group.

TABLE 5

| Hot spare disk resource pool | |
|---|---|
| identifier | Matched RAID group |
| Hot spare disk resource pool 1 | RAID 5 |

When the RAID controller receives information about a faulty disk, the RAID controller can quickly determine, based on the information about the faulty disk (a type and a capacity of the faulty disk) and the mapping relationship, a hot spare disk resource pool that matches a RAID group in which the faulty disk is located, and selects an idle disk as a hot spare disk to complete data restoration processing. The information about the faulty disk includes the type and the capacity of the faulty disk.

It is noteworthy that when the RAID controller is implemented by a processor of the service node, the mapping relationship between the hot spare disk resource pool and the RAID group is stored in a memory of the service node, or when the RAID controller is implemented by a RAID controller in a RAID card, the mapping relationship between the hot spare disk resource pool and the RAID group is stored in a memory of the RAID card.

It is also noteworthy that the method shown in FIG. 2 is described using one storage node and one service node as an example. In a specific implementation process, when the troubleshooting system includes a plurality of storage nodes, a storage controller of each storage node may obtain information about an idle disk of the storage node on which the storage controller is located, and send the information about the idle disk to the RAID controller of the service node. The RAID controller may create a hot spare disk resource pool based on the obtained information about the idle disk of each storage node. In addition, a quantity of storage nodes may be adjusted based on a specific service requirement, to be specific, a quantity of idle disks may be expanded infinitely based on a service requirement in order to resolve a problem of a limited quantity of hot spare disks in the other approaches.

Based on the foregoing description, the RAID controller in each service node may obtain information that is about an idle disk in a storage resource pool and that is determined by the storage controller, create the hot spare disk resource pool based on the information about the idle disk, and when creating the RAID group, match the hot spare disk resource pool with the RAID group. When there is a faulty disk in the RAID group, the RAID controller may select one hot spare disk resource pool from the matched hot spare disk resource pools and select an idle disk in the hot spare disk resource pool to perform data restoration of the faulty disk. In the present application compared with a technical solution of using a local disk of a service node as a hot spare disk in the other approaches, the hot spare disk resource pool includes an idle disk of a cross-network storage node, and the storage node may be expanded infinitely. Correspondingly, the idle disk in the hot spare disk resource pool may be expanded. This resolves a problem of a limited quantity of hot spare disks in the other approaches, thereby improving reliability of an entire system. In addition, when creating the RAID group, the RAID controller of the service node may use all the local disks of the service node as a data disk or a parity disk of the RAID group, and does not need to reserve the local disk as the hot spare disk, thereby improving utilization of the local disk.

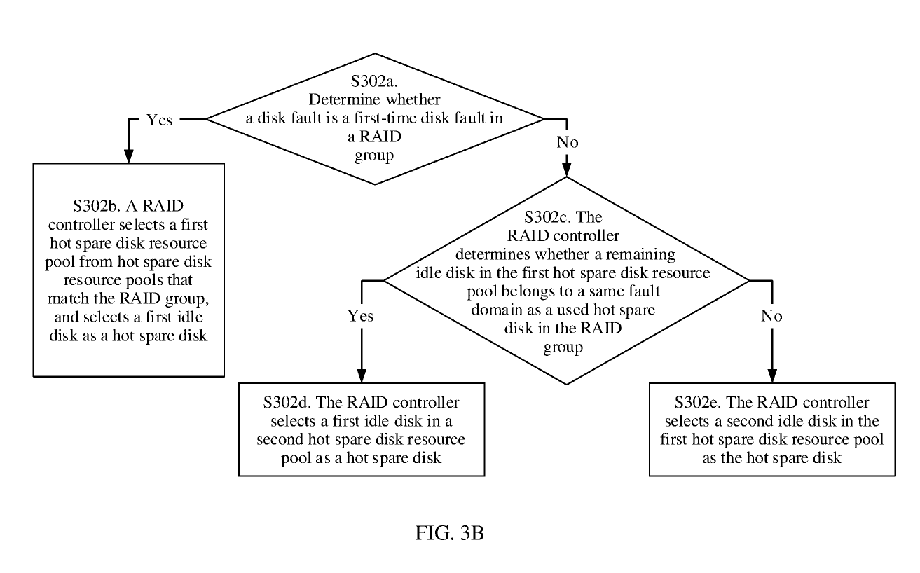

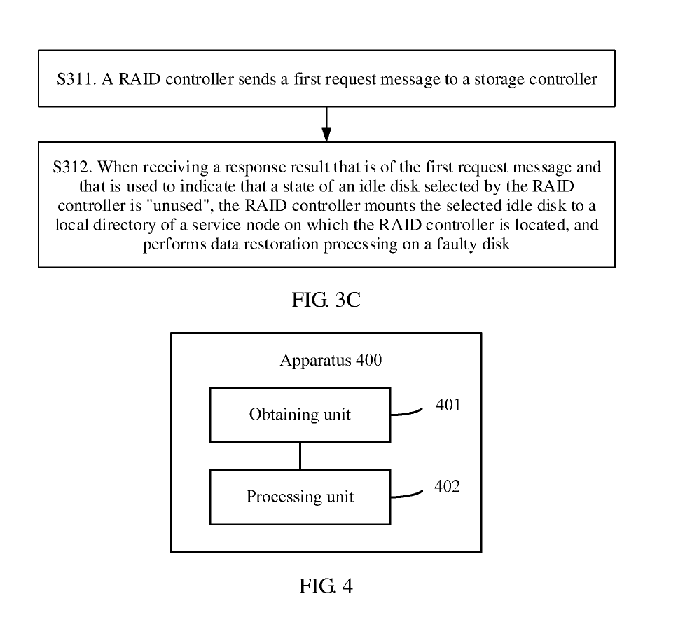

Further, with reference to FIG. 3A, a hot spare disk management method provided in the present application is described in detail. As shown in the figure, the method includes the following steps.

Step 301. A RAID controller obtains information about a faulty disk in any RAID group in a service node on which the RAID controller is located.

Further, the RAID controller may learn of all RAID groups in the service node using metadata information, and monitor a disk of each RAID group in the service node on which the RAID controller is located. When a disk is faulty, the RAID controller may determine a capacity and a type of the faulty disk based on information about the faulty disk.

Step 302. The RAID controller selects an idle disk from a hot spare disk resource pool that matches the RAID group to restore data of the faulty disk.

Further, the RAID controller selects, based on information about a hot spare disk resource pool that is recorded by the RAID controller, the hot spare disk resource pool that matches the RAID group in which the faulty disk is located. A capacity of the disk in the hot spare disk resource pool is greater than or equal to the capacity of the faulty disk, and a type of the disk in the hot spare disk resource pool is the same as the type of the faulty disk.

A process of selecting, by the RAID controller, the hot spare disk resource pool and a hot spare disk is shown in FIG. 3B, and the method includes the following steps.

Step 302a. The RAID controller determines whether the disk fault is a first-time hard disk fault in the RAID group.

The metadata information of the RAID controller further includes information about a member disk and troubleshooting information of each RAID group. The troubleshooting information includes an identifier, a capacity, and a type of a faulty disk, and hot spare disk information used to restore the faulty disk. The hot spare disk information includes a capacity and a type of a hot spare disk, an area in which the hot spare disk is located, and a hot spare disk resource pool to which the hot spare disk belongs. When a disk fault occurs on any RAID group in the service node, the RAID controller may determine, based on the metadata information, whether the disk fault is a first-time disk fault in the RAID group. When there is no troubleshooting information of the RAID group in the metadata information, it indicates that the hard disk fault in the RAID group is the first-time hard disk fault, and step 302b is to be performed. When troubleshooting information of the RAID group is recorded in the metadata information, it indicates that the disk fault in the RAID group is not the first-time hard disk fault, and step 302c is to be performed.

Step S302b. When the hard disk fault is the first-time hard disk fault in the RAID group, the RAID controller selects a first hot spare disk resource pool from the hot spare disk resource pools that match the RAID group, and selects a first idle disk as a hot spare disk.

The RAID controller may determine the first hot spare disk resource pool in any one of the following manners.

Manner 1: Based on an identifier of a hot spare disk resource pool, the RAID controller selects, from one or more hot spare disk resource pools that match the RAID group, one hot spare disk resource pool as the first hot spare disk resource pool.

Manner 2: The RAID controller randomly selects, from one or more hot spare disk resource pools that match the RAID group, one hot spare disk resource pool as the first hot spare disk resource pool.

A capacity of an idle disk in the first hot spare disk resource pool is greater than or equal to the capacity of the faulty disk, and a type of the idle disk in the first hot spare disk resource pool is the same as the type of the faulty disk.

Further, after determining the first hot spare disk resource pool, the RAID controller may determine the first idle disk as the hot spare disk in any one of the following manners.

Manner 1: Based on an identifier of a disk, the RAID controller selects an idle disk from the first hot spare disk resource pool as the first idle disk.

Manner 2: The RAID controller randomly selects an idle disk from the first hot spare disk resource pool as the first idle disk.

Step 302c. When the disk fault is not the first-time hard disk fault in the RAID group, the RAID controller determines whether a remaining idle disk in a first hot spare disk resource pool belongs to a same fault domain as a used hot spare disk in the RAID group.

When the disk fault is not the first-time hard disk fault in the RAID group, the RAID controller needs to determine whether the remaining idle disk in the first hot spare disk resource pool belongs to the same fault domain as the used hot spare disk in the RAID group. If the remaining idle disk and the used hot spare disk belong to the same fault domain, step 302d is to be performed, or if the remaining idle disk and the used hot spare disk do not belong to the same fault domain, step 302e is to be performed.

Step 302d. When the remaining idle disk in the first hot spare disk resource pool and the used hot spare disk in the RAID group belong to the same fault domain, the RAID controller selects a second hot spare disk resource pool from the hot spare disk resource pools that match the RAID group, and selects a first idle disk in the second hot spare disk resource pool as the hot spare disk.

The second hot spare disk resource pool is any hot spare disk resource pool other than the first hot spare disk resource pool in the hot spare disk resource pools that match the RAID. A method for selecting the second hot spare disk resource pool and the first idle disk in the second hot spare disk resource pool is the same as that in step 302b, and details are not described herein again. A type of the first idle disk in the second hot spare disk resource pool is the same as the type of the faulty disk, a capacity of the first idle disk in the second hot spare disk resource pool is greater than or equal to the capacity of the faulty disk, and the first idle disk in the second hot spare disk resource pool and the first idle disk in the first hot spare disk resource pool belong to different fault domains.

Step 302e. When the remaining idle disk in the first hot spare disk resource pool and the used hot spare disk in the RAID group do not belong to the same fault domain, the RAID controller selects a second idle disk from the first hot spare disk resource pool as the hot spare disk.

Further, the RAID controller may create a resource pool based on at least one of the capacity, the type, and the fault domain. When the RAID controller creates the hot spare disk resource pool by considering only the capacity and/or the type, one hot spare disk resource pool may include different idle disks of a same fault domain, or may include idle disks of different fault domains. To resolve a problem of data loss caused by another fault of two or more used hot spare disks of a same area in a same RAID group, the RAID controller may select, from the used first hot spare disk resource pool, an idle disk of a different fault domain as the hot spare disk, for example, select the second idle disk from the first hot spare disk resource pool as the hot spare disk. A capacity of the second idle disk in the first hot spare disk resource pool is greater than or equal to the capacity of the faulty disk, a type of the second idle disk in the first hot spare disk resource pool is the same as the type of the faulty disk, and the first idle disk and the second idle disk in the first hot spare disk resource pool belong to different fault domains. When the remaining idle disk in the first hot spare disk resource pool and the used hot spare disk in the RAID group do not belong to the same fault domain, a method for selecting the second idle disk in the first hot spare disk resource pool is the same as that in step 302b, and details are not described herein again.

Optionally, when no idle disk in the first hot spare disk resource pool belongs to the same area as the first idle disk in the first hot spare disk resource pool, the RAID controller may further select, from another hot spare disk resource pool that matches the RAID group, an idle disk as the hot spare disk. A method for selecting the hot spare disk resource pool and the idle disk is the same as that in step S302b, and details are not described herein again.

Based on the description in step 302a to step 302e, when a plurality of hard disk faults occur in the same RAID group, the RAID controller may further select the hot spare disk based on the capacity, the type, and the fault domain of the idle disk in order to avoid a problem of data loss caused by another fault of two hot spare disks when the plurality of disk faults occur in the same RAID group, and the hot spare disks belong to the same fault domain, thereby improving application reliability.

Optionally, as shown in FIG. 3C, after the RAID controller selects the hot spare disk from the hot spare disk resource pool that matches the RAID group, the method further includes the following steps.

Step 311. The RAID controller sends a first request message to a storage controller.

Further, in the fault troubleshooting system shown in FIG. 1, the RAID controller of each service node may create a hot spare disk resource pool, and establish a mapping relationship between a RAID group in a service node corresponding to the RAID controller and the hot spare disk resource pool. The idle disks included in the hot spare disk resource pools created by the RAID controllers of different service nodes may be the same. When the RAID controller of any service node selects an idle disk as a hot spare disk, to avoid that the selected idle disk has been used by another RAID controller, it is necessary to send the first request message to a storage controller of a storage node in which the selected idle disk is located. The first request message is used to determine that a state of the selected idle disk is “unused”.

Step 312. When receiving a response result that is of the first request message and that is used to indicate that a state of the idle disk selected by the RAID controller is “unused”, the RAID controller mounts the selected idle disk to a local directory of a service node on which the RAID controller is located, and performs data restoration processing on a faulty disk.

Further, when the storage controller of the idle disk selected by the RAID controller determines that the state of the idle disk is “unused”, the response result of the first request message sent to the RAID controller by the storage controller indicates that the state of the idle disk is “unused”. Correspondingly, after receiving the response result of the first request message, the RAID controller mounts the first idle disk to the local directory of the service node on which the RAID controller is located, for example, executes a mount command (for example, mount storage node Internet Protocol (IP): idle disk drive letter) in the LINUX system, mounts a directory of the storage node to the local directory, and performs data restoration processing on the faulty disk.

After mounting the selected idle disk locally, the RAID controller may update locally-stored troubleshooting information in metadata information that records a RAID group relationship. The hot spare disk information that is used to restore the faulty disk and that is in the troubleshooting information is mainly updated. The hot spare disk information includes a capacity and a type of a hot spare disk, an area in which the hot spare disk is located, and a hot spare disk resource pool to which the hot spare disk belongs. The RAID controller rewrites the data of the faulty disk into the hot spare disk based on data in a non-faulty data disk and data in a non-faulty parity disk in the metadata information in order to complete data restoration processing of the faulty disk.

Based on the foregoing description, when a RAID controller of any service node in the troubleshooting system receives information about a faulty disk in any RAID group in the service node, the RAID controller may select, based on the information about the faulty disk, a hot spare disk resource pool from hot spare disk resource pools that match the RAID group, and select an idle disk from the hot spare disk resource pool as the hot spare disk for data restoration. In addition, the hot spare disk may be provided by an idle disk of a storage node in a hot spare disk resource pool form. A quantity of storage nodes may be continuously increased based on a service requirement. Correspondingly, the disk in the hot spare disk resource pool may be continuously expanded. A quantity of hot spare disks is not limited in this method compared with the other approaches. This resolves a problem of a limited quantity of hot spare disk in the other approaches. Further, a fault domain of the idle disk is considered. The RAID controller may select the idle disk based on a capacity, a type, and a fault domain of the idle disk in order to avoid recurrence of data loss caused by the fault of the hot spare disk after the idle disk of the same fault domain is used to restore data in the same RAID group, thereby improving reliability of a service application and an entire system.

It is noteworthy that, for ease of description, the foregoing method embodiments are described as a series of action combinations. However, a person skilled in the art should know that the present application is not limited by a described action sequence. Another proper step combination figured out by a person skilled in the art according to the foregoing described content also falls within the protection scope of the present application.

The method of the troubleshooting method provided in the embodiments of the present application is described in detail above with reference to FIG. 1 to FIG. 3C, and a troubleshooting apparatus and device provided in the embodiments of the present application are described below with reference to FIG. 4 and FIG. 6.

FIG. 4 is a schematic diagram of a troubleshooting apparatus 400 according to the present application. As shown in FIG. 4, the apparatus 400 includes an obtaining unit 401 and a processing unit 402.

The obtaining unit 401 is configured to obtain information about a faulty disk in a RAID group, where the information about the faulty disk includes a capacity and a type of the faulty disk.

The processing unit 402 is configured to select an idle disk from a hot spare disk resource pool that matches the RAID group to restore data of the faulty disk, where the hot spare disk resource pool is pre-created by a RAID controller, a hot spare disk resource pool includes one or more idle disks in the at least one storage node, a capacity of the idle disk selected by the RAID controller is greater than or equal to the capacity of the faulty disk, and a type of the idle disk selected by the RAID controller is the same as the type of the faulty disk.

It should be understood that the apparatus 400 in this embodiment of the present application may be implemented using an ASIC, or a programmable logic device (PLD). The PLD may be a complex PLD (CPLD), an FPGA, a generic array logic (GAL), or any combination thereof. Alternatively, the troubleshooting method shown in FIG. 2 to FIG. 3C may be implemented using software, and the apparatus 400 and the modules of the apparatus 400 may also be software modules.

Optionally, the obtaining unit 401 is further configured to obtain information about the idle disk that is sent by the storage controller, where the information about the idle disk includes the type and the capacity of the idle disk.

The processing unit 402 is further configured to create at least one hot spare disk resource pool, where each hot spare disk resource pool includes at least one idle disk that is of at least one storage node and that has a same capacity and/or a same type.

The processing unit 402 is further configured to determine, based on a type and a capacity of a hard disk in the RAID group, one or more hot spare disk resource pools that match the RAID group when creating the RAID group, and record a mapping relationship between the RAID group and the one or more hot spare disk resource pools that match the RAID group.

That the processing unit 402 selects the idle disk from the hot spare disk resource pool that matches the RAID group to restore data of the faulty disk includes selecting, based on the mapping relationship and the information that is about the faulty disk and that is obtained by the obtaining unit 401, the idle disk from the hot spare disk resource pool that matches the RAID group to restore data of the faulty disk.

Optionally, the information about the idle disk further includes information about a fault domain of the idle disk, the idle disk selected by the processing unit 402 is not in a same fault domain as a used hot spare disk in the RAID group, the information about the fault domain is used to identify a relationship between areas in which different hard disks are located, data may be lost when different disks in a same fault domain are faulty simultaneously, and data may not be lost when different disks in different fault domains are faulty simultaneously.

Optionally, a state of the idle disk selected by the processing unit is “unused”.

Further, the processing unit 402 in the apparatus 400 is further configured to send a first request message to the storage controller, where the first request message is used to determine a state of an idle disk selected by the controller.

The obtaining unit 401 is further configured to receive a response result that is of the first request message and that is used to indicate that the state of the idle disk selected by the controller is “unused”.

The processing unit 402 is further configured to mount the selected idle disk locally, and perform faulty data restoration processing on the RAID group.

Optionally, that the processing unit selects the idle disk as a hot spare disk to restore the data of the faulty disk includes rewriting, based on data of a non-faulty data disk and parity disk in the RAID group, the faulty disk data into the hot spare disk selected by the RAID controller.

The apparatus 400 according to this embodiment of the present application may correspondingly perform the method described in the embodiments of the present application. In addition, the foregoing and other operations and/or functions of the units in the apparatus 400 are separately used to implement a corresponding procedure of the method in FIG. 2 to FIG. 3C. For brevity, details are not described herein again.

Based on the foregoing description, the apparatus 400 provided in the present application provides a cross-node hot spare disk implementation, creates the hot spare disk resource pool using the idle disk of the storage node, and establishes a mapping relationship between the hot spare disk resource pool and the RAID group. When there is a faulty disk in any RAID group, from a hot spare disk resource pool that matches the RAID group in which the faulty disk is located, an idle disk is selected as the hot spare disk in order to restore the faulty disk data. A quantity of storage nodes and a quantity of idle disks in the storage nodes may be expanded based on a service requirement. Correspondingly, a quantity of hot spare disk resource pools may be unlimited. This resolves a problem that a quantity of hot spare disks is limited when a local disk of a service node is used as the hot spare disk in the other approaches. In addition, when a plurality of disk faults occur in a same RAID group, a plurality of hot spare disks may be provided using the hot spare disk resource pool in order to improve reliability of an entire system. In addition, all local disks of the service node may be used as a data disk or a parity disk of the RAID group, which improves utilization of the local disk.

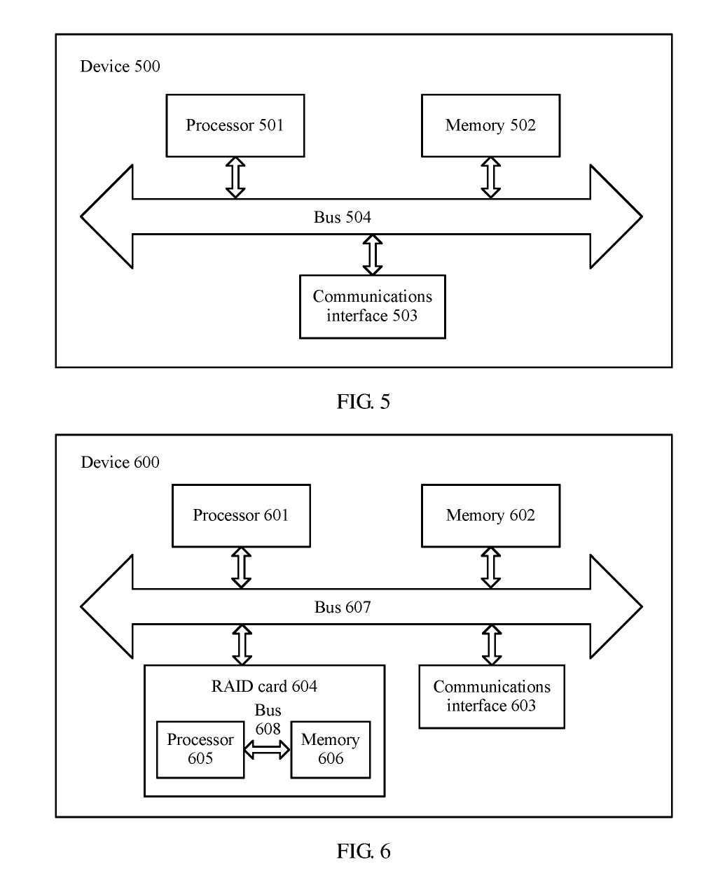

FIG. 5 is a schematic diagram of a troubleshooting device 500 according to an embodiment of the present application. As shown in FIG. 5, the device 500 includes a processor 501, a memory 502, a communications interface 503, and a bus 504. The processor 501, the memory 502, and the communications interface 503 perform communication using the bus 504, or may implement communication using another means such as wireless transmission. The memory 502 is configured to store an instruction, and the processor 501 is configured to execute the instruction stored in the memory 502. The memory 502 stores program code, and the processor 501 may invoke the program code stored in the memory 502 to perform the following operations of obtaining information about a faulty disk in a RAID group, where the information about the faulty disk includes a capacity and a type of the faulty disk, and selecting an idle disk from a hot spare disk resource pool that matches the RAID group to restore data of the faulty disk, where the hot spare disk resource pool is pre-created by the device 500, the hot spare disk resource pool includes one or more idle disks in at least one storage node, a capacity of the idle disk selected by the device 500 is greater than or equal to the capacity of the faulty disk, and a type of the idle disk selected by the device 500 is the same as the type of the faulty disk.

It should be understood that in the embodiment of the present application, the processor 501 may be a CPU, or the processor 501 may be another general purpose processor, a DSP, an ASIC, an FPGA or another programmable logic device, a discrete gate, a transistor logic device, a discrete hardware component, or the like. The general purpose processor may be a microprocessor, or the processor 501 may be any conventional processor or the like.

The memory 502 may include a ROM and a RAM, and provide an instruction and data to the processor 501. A part of the memory 502 may further include a non-volatile RAM (NVRAM). For example, the memory 502 may further store information about a device type.

The bus 504 may further include a power bus, a control bus, a status signal bus, and the like, in addition to a data bus. However, for clarity of description, various types of buses in the figure are marked as the bus 504.

It should be understood that the troubleshooting device 500 according to this embodiment of the present application corresponds to the service node described in FIG. 1 in the embodiments of the present application. The troubleshooting device 500 according to this embodiment of the present application may correspond to the troubleshooting apparatus 400 in the embodiments of the present application, and may correspond to a corresponding entity that performs the methods in FIG. 2 to FIG. 3B according to the embodiments of the present application, and the foregoing and other operations and/or functions of the modules in the device 500 are respectively intended to implement the corresponding procedures of the methods in FIG. 2 to FIG. 3C. Details are not described again herein for brevity.

FIG. 6 is a schematic diagram of another troubleshooting device 600 according to an embodiment of the present application. As shown in FIG. 6, the device 600 includes a processor 601, a memory 602, a communications interface 603, a RAID card 604, and a bus 607. The processor 601, the memory 602, the communications interface 603, and the RAID card 604 perform communication using the bus 607, or implement communication using another means such as wireless transmission. The RAID card 604 includes a processor 605, a memory 606, and a bus 608. The processor 605 and the memory 606 perform communication using the bus 608. The memory 606 is configured to store an instruction, and the processor 605 is configured to execute the instruction stored in the memory 606. The memory 606 stores program code, and the processor 605 may invoke the program code stored in the memory 606 to perform the following operations obtaining information about a faulty disk in a RAID group, where the information about the faulty disk includes a capacity and a type of the faulty disk, and selecting an idle disk from a hot spare disk resource pool that matches the RAID group to restore data of the faulty disk, where the hot spare disk resource pool is pre-created by the device 600, the hot spare disk resource pool includes one or more idle disks in the at least one storage node, a capacity of the idle disk selected by the device 600 is greater than or equal to the capacity of the faulty disk, and a type of the idle disk selected by the device 600 is the same as the type of the faulty disk.

It should be understood that in the embodiment of the present application, the processor 605 may be a CPU, or the processor 605 may be another general purpose processor, a DSP, an ASIC, an FPGA or another programmable logic device, a discrete gate, a transistor logic device, a discrete hardware component, or the like. The general purpose processor may be a microprocessor, or the processor 605 may be any conventional processor or the like.

The memory 606 may include a ROM and a RAM, and provide an instruction and data to the processor 601. A part of the memory 606 may further include an NVRAM. For example, the memory 606 may further store information about a device type.

The bus 608 and the bus 607 may further include a power bus, a control bus, a status signal bus, and the like, in addition to a data bus. However, for clarity of description, various types of buses in the figure are marked as the bus 608 and the bus 607.

It should be understood that the troubleshooting device 600 according to this embodiment of the present application corresponds to the service node described in FIG. 1 in the embodiments of the present application. The troubleshooting device 600 according to this embodiment of the present application may correspond to the troubleshooting apparatus 400 in the embodiments of the present application, and may correspond to a corresponding entity that performs the methods in FIG. 2 to FIG. 3B according to the embodiments of the present application, and the foregoing and other operations and/or functions of the modules in the device 600 are respectively intended to implement the corresponding procedures of the methods in FIG. 2 to FIG. 3C. Details are not described again herein for brevity.

Optionally, the device 600 may be the RAID card 604 shown in FIG. 6.

In conclusion, the device 500 and the device 600 provided in this application implement a hot spare disk resource pool using an idle disk of a cross-network storage node, and establish a mapping relationship between the hot spare disk resource pool and each RAID group. When there is a faulty disk in any RAID group, one hot spare disk resource pool may be selected from hot spare disk resource pools that match the RAID group, and an idle disk in the hot spare disk resource pool may be selected as a hot spare disk to restore faulty data. A quantity of idle disks in the hot spare disk resource pool may be adjusted based on a service requirement in order to resolve a problem that system reliability is affected by a limited quantity of disks in the hot spare disk resource pool in the other approaches. In addition, all local disks of the service node may be used as a data disk and a parity disk of the RAID group, which improves utilization of the local disk.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the present application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present application essentially, or the part contributing to the other approaches, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present application. The foregoing storage medium includes any medium that can store program code, such as a USB flash drive, a removable disk, a ROM, a RAM, a magnetic disk, or an optical disc.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A troubleshooting method in a system comprising a service node and a plurality of hot spare disk resource pools, the troubleshooting method comprising:
retrieving, by the service node, a type of a faulty disk in the service node;
identifying, by the service node, a first hot spare disk resource pool from the hot spare disk resource pools based on the type of the faulty disk, the first hot spare disk resource pool comprising a plurality of hot spare disks, each of the hot spare disks having a same type as the faulty disk; and
selecting, by the service node, a first idle disk from the hot spare disks to restore data of the faulty disk.

2. The troubleshooting method of claim 1, further comprising creating, by the service node, the hot spare disk resource pools, disks comprised in each hot spare disk resource pool having a same type.

3. The troubleshooting method of claim 1, wherein selecting the first idle disk comprises selecting, by the service node from the first hot spare disk resource pool, a hot spare disk as the first idle disk based on a capacity of the hot spare disk, and the capacity of the hot spare disk being greater than or equal to the faulty disk.

4. The troubleshooting method of claim 3, wherein the service node comprises a redundant array of independent disks (RAID) group, the RAID group comprising member disks, the faulty disk being one of the member disks, and the member disks and the first idle disk respectively belonging to different fault domains.

5. The troubleshooting method of claim 4, wherein after selecting the first idle disk, the troubleshooting method further comprises:
identifying, by the service node, that the RAID group fails for a second time when a second faulty disk in the member disks fails;
retrieving, by the service node, a second type of the second faulty disk;
identifying, by the service node, a second hot spare disk resource pool from the hot spare disk resource pools based on the second type of the second faulty disk;
identifying, by the service node, a second idle disk from a plurality of hot spare disks in the second hot spare disk resource pool;
determining, by the service node, that the member disks and the second idle disk respectively belong to different fault domains; and
selecting, by the service node, the second idle disk to restore data of the second faulty disk.

6. The troubleshooting method of claim 1, further comprising:
sending, by the service node, a request to a node in which the first idle disk locates, the request being configured to confirm whether the first idle disk is unused;
receiving, by the service node, a response to the request, the response indicating that the first idle disk is unused; and
restoring, by the service node, the data of the faulty disk using the first idle disk.

7. A troubleshooting device, comprising:
a memory storing a computer execution instruction; and
a processor coupled to the memory, the computer execution instruction causing the processor to be configured to:
retrieve a type of a faulty disk in a service node;
identify a first hot spare disk resource pool from a plurality of hot spare disk resource pools based on the type of the faulty disk, the first hot spare disk resource pool comprising a plurality of hot spare disks, and each of the hot spare disks having a same type as the faulty disk; and
select a first idle disk from the hot spare disks to restore data of the faulty disk.

8. The troubleshooting device of claim 7, wherein the computer execution instruction further causes the processor to be configured to create the hot spare disk resource pools, disks comprised in each hot spare disk resource pool having a same type.

9. The troubleshooting device of claim 7, wherein the computer execution instruction further causes the processor to be configured to select, from the first hot spare disk resource pool, a hot spare disk as the first idle disk based on a capacity of the hot spare disk, and the capacity of the hot spare disk being greater than or equal to the faulty disk.

10. The troubleshooting device of claim 9, further comprising a redundant array of independent disks (RAID) group coupled to the processor, the RAID group comprising member disks, the faulty disk being one of the member disks, and the member disks and the first idle disk respectively belonging to different fault domains.

11. The troubleshooting device of claim 10, wherein the computer execution instruction further causes the processor to be configured to:
determine that the RAID group fails for a second time when a second faulty disk in the member disks fails;
retrieve a second type of the second faulty disk;
identify a second hot spare disk resource pool from the hot spare disk resource pools based on the second type of the second faulty disk;
identify a second idle disk from a plurality of hot spare disks in the second hot spare disk resource pool;
determine that the member disks and the second idle disk respectively belong to different fault domains; and
select the second idle disk to restore data of the second faulty disk.

12. The troubleshooting device of claim 7, wherein the computer execution instruction further causes the processor to be configured to:
send a request to a node in which the first idle disk locates, the request being configured to confirm whether the first idle disk is unused;
receive a response to the request, the response indicating that the first idle disk is unused; and
restore the data of the faulty disk using the first idle disk.

13. A computer-readable storage medium comprising instructions which, when executed by a computer, cause the computer to:
retrieve a type of a faulty disk in a service node;
identify a first hot spare disk resource pool from a plurality of hot spare disk resource pools based on the type of the faulty disk, the first hot spare disk resource pool comprising a plurality of hot spare disks, each of the hot spare disks having a same type as the faulty disk; and
select a first idle disk from the hot spare disks to restore data of the faulty disk.

14. The computer-readable storage medium of claim 13, wherein the instructions further cause the computer to be configured to create the hot spare disk resource pools, disks comprised in each hot spare disk resource pool having a same type.

15. The computer-readable storage medium of claim 13, wherein when selecting the first idle disk, the instructions further cause the computer to be configured to select, from the first hot spare disk resource pool, a hot spare disk as the first idle disk based on a capacity of the hot spare disk, and the capacity of the hot spare disk being greater than or equal to the faulty disk.

16. The computer-readable storage medium of claim 15, wherein the service node comprises a redundant array of independent disks (RAID) group, the RAID group comprising member disks, the faulty disk being one of the member disks, and the member disks and the first idle disk respectively belonging to different fault domains.

17. The computer-readable storage medium of claim 16, wherein after selecting the first idle disk, the instructions further cause the computer to be configured to:
determine that the RAID group fails for a second time when a second faulty disk in the member disks fails;
retrieve a second type of the second faulty disk;
identify a second hot spare disk resource pool from the hot spare disk resource pools based on the second type of the second faulty disk;
identify a second idle disk from a plurality of hot spare disks in the second hot spare disk resource pool;
determine that the member disks and the second idle disk respectively belong to different fault domains; and
select the second idle disk to restore data of the second faulty disk.

18. The computer-readable storage medium of claim 13, wherein the instructions further cause the computer to be configured to:
send a request to a node in which the first idle disk locates, the request being configured to confirm whether the first idle disk is unused;
receive a response to the request, the response indicating that the first idle disk is unused; and
restore the data of the faulty disk using the first idle disk.

19. The computer-readable storage medium of claim 13, wherein when identifying the first hot spare disk resource pool, the instructions further cause the computer to be configured to randomly identify the first hot spare disk resource pool from the hot spare disk resource pools.

20. The computer-readable storage medium of claim 13, wherein when selecting the first idle disk from the hot spare disks, the instructions further cause the computer to be configured to randomly select the first idle disk from the hot spare disks.
